(19) United States
(12) Patent Application Publication
(10) Pub. No.: US 2022/0247342 A1
(43) Pub. Date: Aug. 4, 2022

(54) Multi-tier Elevated Super-structural Novel Renewable Energy Infrastructures (MESNREI)

(71) Applicant: UJJAWAL SHARMA, Silver Spring, MD (US)

(72) Inventors: CHANDAN SHARMA, GHAZIABAD (IN); PRAVEEN SHARMA, GHAZIABAD (IN); UJJAWAL SHARMA, SILVER SPRING, MD (US)

(21) Appl. No.: 17/614,523

(22) PCT Filed: Jun. 2, 2019
(86) PCT No.: PCT/IN2019/050430

§ 371 Date: Nov. 28, 2021

(51) Int. Cl. H02S 10/12; F03D 9/00; F03D 7/02; F03D 13/25; H02S 40/22

(52) U.S. Cl. CPC H02S 10/12; F03D 9/007; F03D 7/0204; F05B 2240/95; F03D 13/25; H02S 40/22; F05B 2240/922; F03D 7/0224

(57) ABSTRACT

This invention is related to the field of Wind & Solar Energy applications and associated infrastructural facilities, which will be an environmental friendly set-up on a small land area for better utilisation of wind & solar resources available in that particular surroundings, harnessing increased efficiencies from the novel wind turbines plus the inventive solar shells.

The Multi-tier Elevated Super-structural Novel Renewable Energy Infrastructures (MESNREI) is brought, that will host various types of inventive Wind Turbines including the novel enclosed Cage Guided Wind Turbines & the inventive solar shells that shall produce electricity in a more efficient, advanced and reliable way, utilising only a small land area inculcating better use of wind & solar resources available at that particular site.

### FIELD OF INVENTION

This invention is related to the field of Wind & Solar Energy applications and associated infrastructural facilities, which will be an environmental friendly set-up on a small land area for better utilisation of wind & solar resources available in that particular surroundings, harnessing increased efficiencies from the novel enclosed cage guided wind turbines plus the inventive solar shells.

### BACKGROUND OF THE INVENTION WITH DRAWBACK ASSOCIATED WITH KNOWN ART

The patent search does not find out any such Multi-Tier Elevated Super-structural Energy Infrastructure for wind turbines & solar shells, which resembles with this entirely new technique. Also, there are various disadvantages associated with the prevalent wind energy sites such as installation of wind turbines might not be the most profitable use of such large land per unit of the less-reliable & lesser efficient energy production, threat to wild life, noise pollution, aesthetic impact etc.

The primary costs of wind turbines include construction and maintenance, which certainly not that economical considering the amount of energy produced. New technology is certainly needed to lower costs, increase reliability and energy production, solving regional deployment issues, expanding the resource area, developing infrastructure and manufacturing facilities, and mitigating known environmental impacts.

### OBJECT OF INVENTION

The object of invention is to bring out an innovative Multi-tier Elevated Super-structural Novel Renewable Energy Infrastructures (MESNREI) by which a system could be implemented in order to reduce large land resources, maximise utilisation of wind & solar energy at a particular site through the Multi-tier structural facilities with better achieved efficiency through the novel enclosed cage guided wind turbine systems and the inventive solar shells.

### STATEMENT OF INVENTION

The invention states that a novel and highly efficient wind & solar energy generation facility or a wind & solar farm is being realised through a Multi-Tier Elevated Super-structural Infrastructures that will host various types of Wind Turbines including the novel enclosed Cage Guided Wind Turbines & the inventive solar shells that shall produce electricity in a more efficient, advanced and reliable way, utilising small land areas inculcating better use of wind & solar resources.

### A SUMMARY OF INVENTION

A summary of invention is that a novel wind & solar energy generation facility is conceptualised through a Multi-tier Elevated Super-structural Novel Renewable Energy Infrastructures (MESNREI), that will host various types of Wind Turbines including the novel enclosed Cage Guided Wind Turbines & the inventive solar shells that shall produce electricity in a more efficient, advanced and reliable way, utilising only a small land area inculcating better use of wind & solar resources available at that particular site.

### A BRIEF DESCRIPTION/SPECIFICATION OF THE ACCOMPANYING DRAWING

This technique will focus on an inventive framework as described below with the following drawings accompanying the same:

FIG. 1: Multi-tier Elevated Super-structural Novel Renewable Energy Infrastructures (MESNREI) system overview

FIG. 2: Entire MESNREI system oriented in various form/shape/pattern/size as seen from top

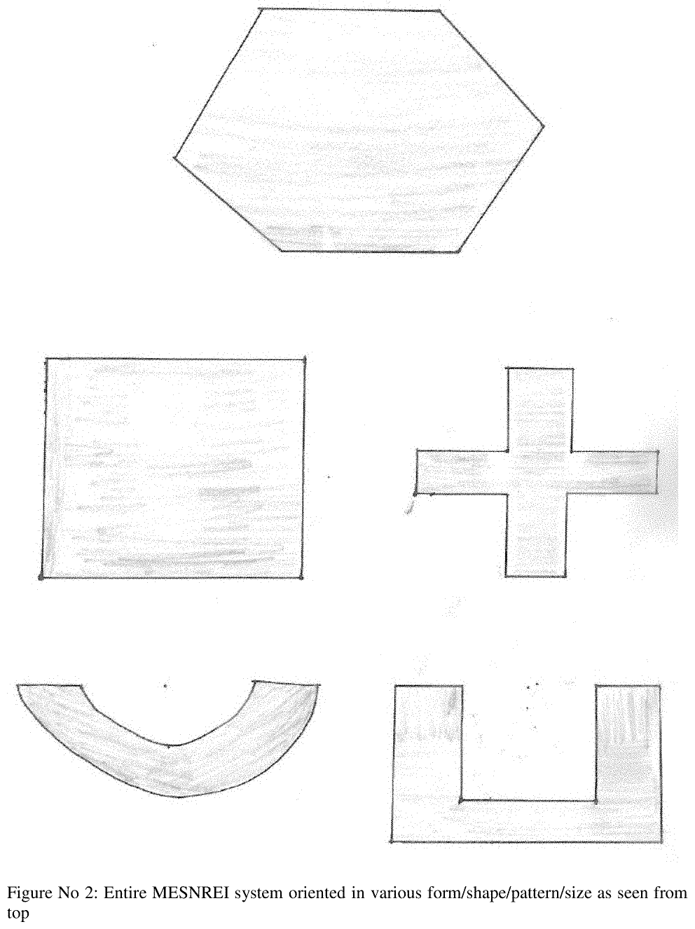

FIG. 3: Enclosed Cage Flapper Guiding systems & flapper vertical edge as seen from wind turbine showing various noise attenuation designs (any one or a combination could be selected)

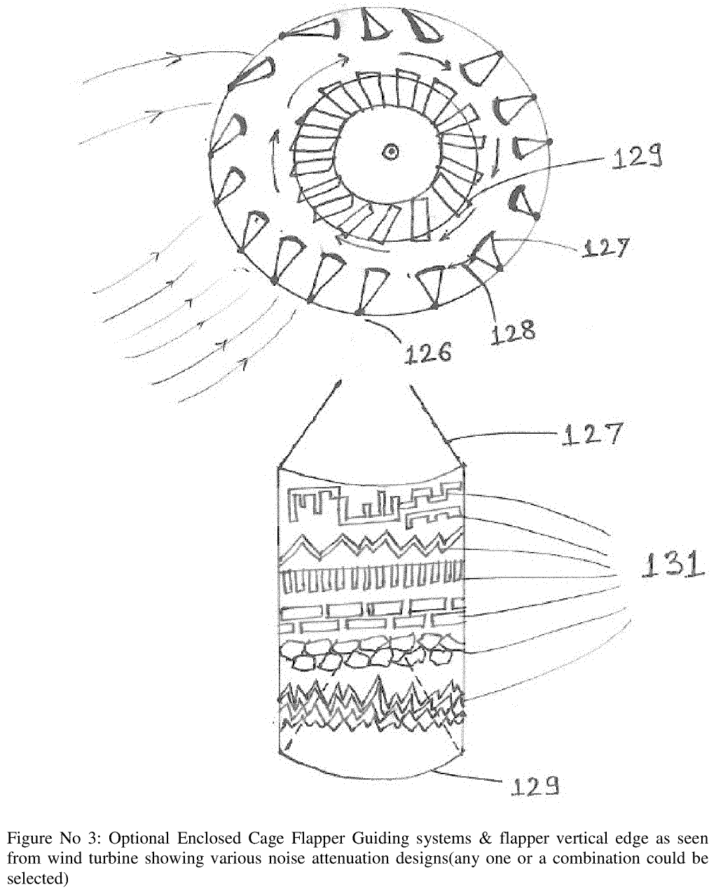

FIG. 4: Novel solar panels flushed mounted into each of the blade of wind turbine

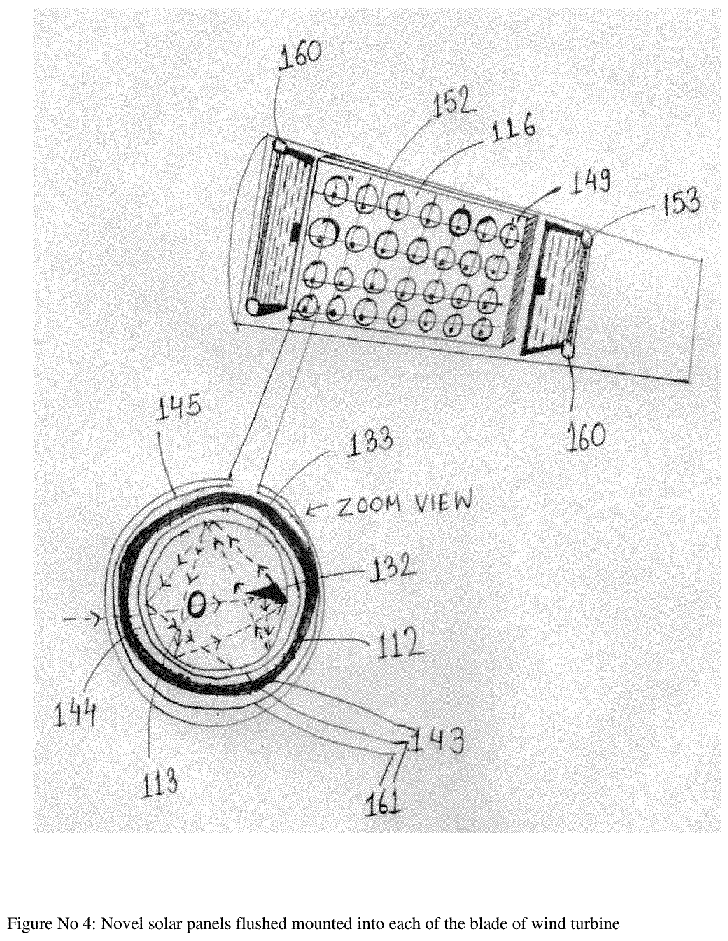

FIG. 5: Solar photovoltaic shells

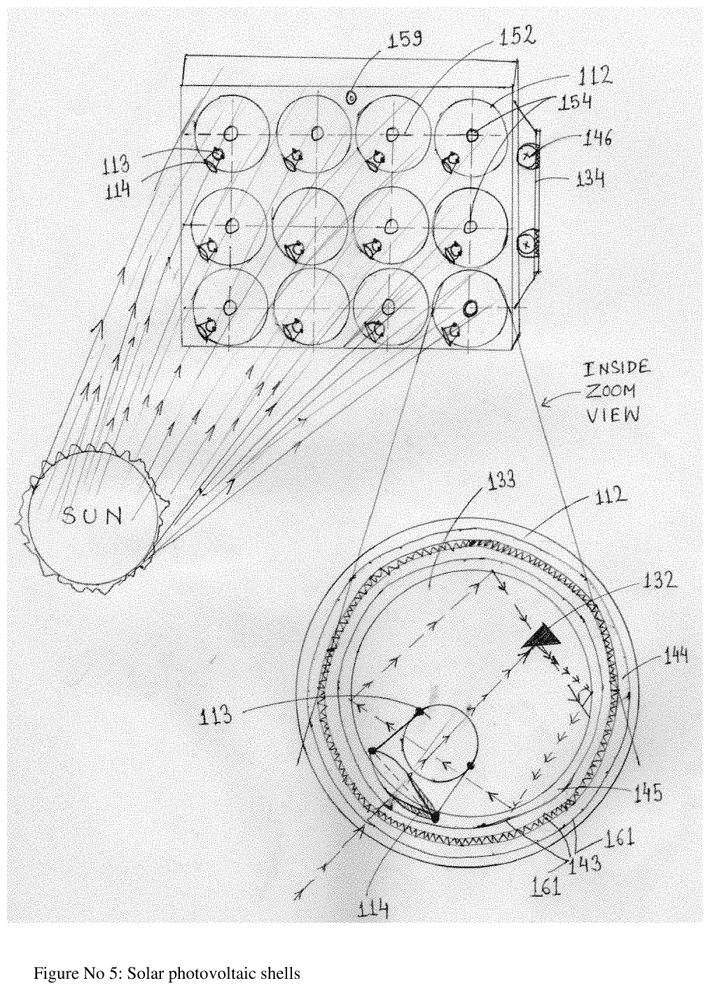

FIG. 6: Portable wind turbines in air floating balloon/parachute enclosures for high altitudes applications

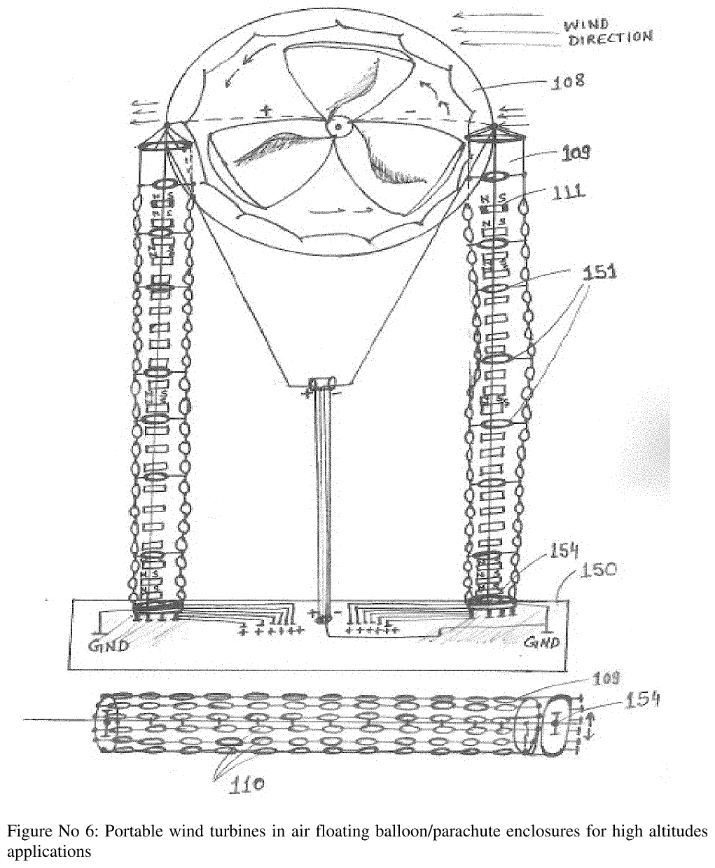

FIG. 7: Pedestal base-plate overview

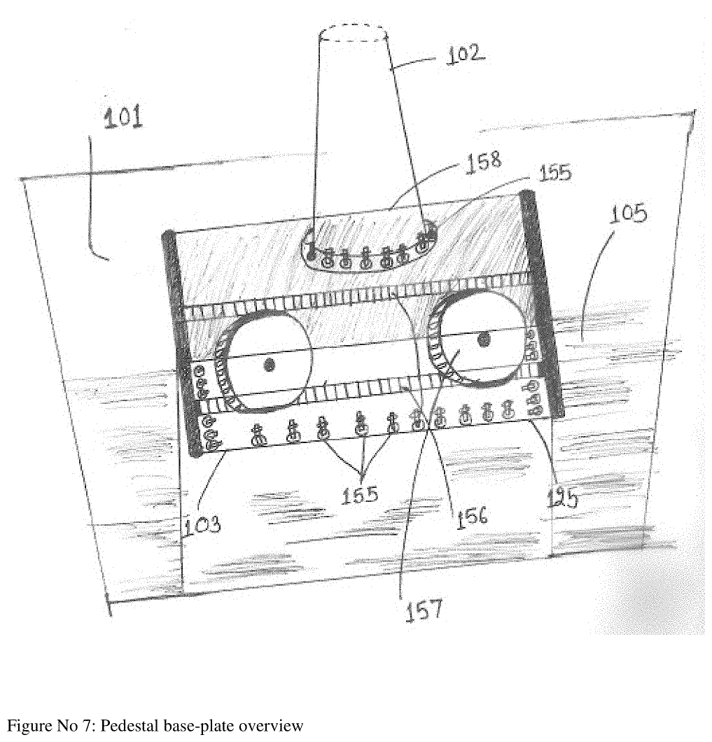

FIG. 8: A typical Industrial/domestic grade type platform grating systems with platforms helipad at the top roof

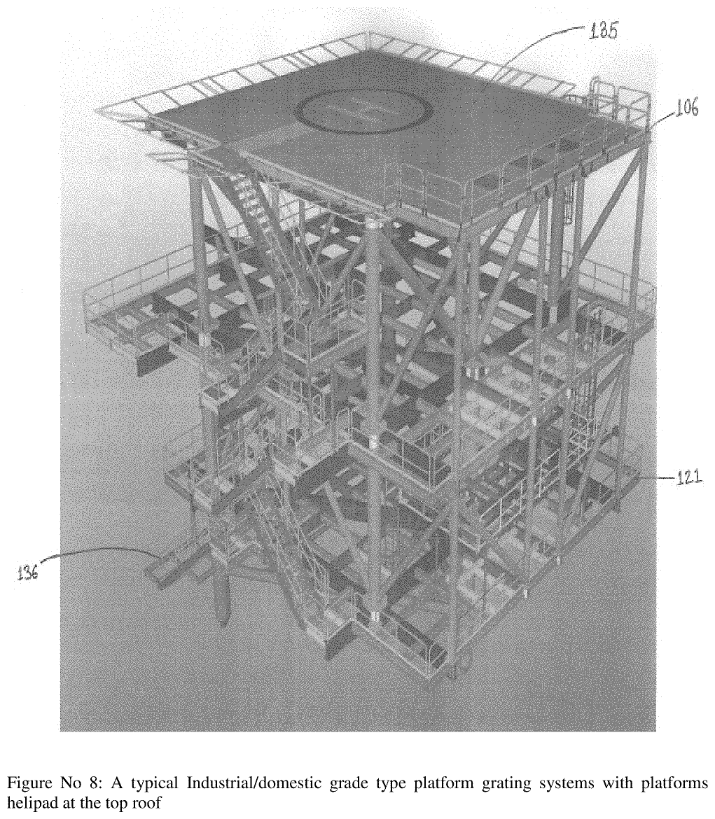

### MODE(S) FOR CARRYING OUT THE INVENTION OR A DETAILED DESCRIPTION OF THE INVENTION

Most Wind (Wind-Solar) hybrid infrastructures have large land used per unit of the less-reliable & lesser efficient wind energy production, pose threat to natural habitat, and incur noise pollution along with effecting aesthetics in case of wind farms.

New technology is the need of the hour that will lower costs, increase reliability and energy production, solving regional deployment issues, expanding the resource area, developing infrastructure and manufacturing facilities, and mitigating known environmental impacts meeting the energy demands of the society.

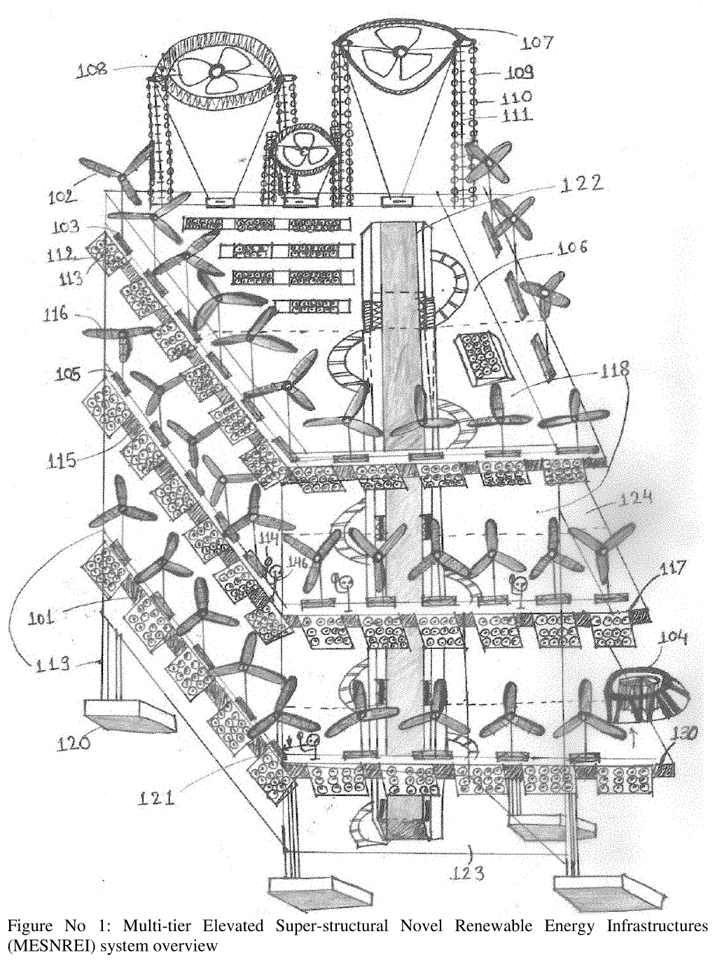

The Multi-tier Elevated Super-structural Novel Renewable Energy Infrastructures (MESNREI) 100 (all components made up of any suitable material) is brought to eliminate such associated drawbacks, which is characterized by the followings:
a) A plurality of vertically erected structural platforms 101 placed one above the other (entire assembly oriented in any form/shape/pattern/size) for various types of plurality of wind turbines 102 having a novel advanced harmonic mean predictive Yaw/Pitch control system 135 consisting of intelligent customized sub-algorithms, installed on the novel lateral moving pedestal base-plate 103, including optional novel Enclosed Cage Flapper Guided assembly systems 104 for some types of wind turbines 102 as per usages, on extended portions 105 of each of the platform 101 at various elevations. This MESNREI system 100 is designed to place wind turbines 102 in an efficient multi-directional patterns on each of the single tier/platform 101 of this system at a particular area. This is in order to obtain maximum efficiency from natural winds at that particular site. This feature is depicted in FIG. 1 as shown;
b) Top roof 106 facility system for installing portable wind turbines 107 in air floating balloon/parachute enclosures 108 for high altitudes applications having supports consisting of hollow cylindrical piping 109 consisting of plurality of electrical conducting loops/mesh 110, along with at least 1 free moving rod comprising magnets (permanent) 111 (magnets placed at all of the same elevations as said electrical loops) placed inside each of the hollow cylindrical piping 109, along with arrangements of solar panels 116 having arrays of novel protruded larger solar photovoltaic shells (outside & inside) 112 with a hole 113 along with solar concentrated collector systems 114;
c) Balcony type railing systems 115 along the above extended portions 105 shall be from all sides at each platform for safety, access, maintenance & shall also host a plurality of novel solar panels 116 along the railings top edges 117 containing novel protruded solar photovoltaic shells 112 with a hole 113 along with solar concentrated collector systems 114 or a larger solar photovoltaic shells 112 as standalone items, as can be figured out in FIG. 1.

The MESNREI system 100 as defined shall also have the following features but not limited to:
a) Industrial/domestic grade type platform grating systems 118 of any shape & size at all platform elevations supported on, columns, beams etc i.e along with all structural components 119, civil/structural foundations 120 such as the pile/pier/raft/cantilever/truss systems etc that are erected as per industry practices/rules/codes/statutory standards/general standards. The minimum elevation at which first platform 121 shall be build depends on the sufficient annual average workable natural wind availability at said particular elevation at that site. The material of construction of the components of these structural systems 119 shall be of any material suitable for the specific application;
b) At the centre area of the said MESNREI 100, there shall be an arrangement of elevator/stair-case 122 for going up & down from/to the grade level 123 to the different platform elevations/top roof for on-shore installations. For off-shore installations, there shall be stair-case facility from penultimate platform apart from arrangement of elevator/stair-case 122 for going up & down from/to the first platform 121 to the different platform elevations upto the penultimate platform 124;
c) The pedestal base-plate 103 shall have provision of bottom base-plate 125 (with all mechanical, electrical, electronic components & accessories such as studs, nuts & gaskets etc 155, having at the least, roller wheels 157 with brake drum/disc/any, brake shoe lining, return spring, dedicated control system etc) for feedback lateral to-fro movement control along with provisions of maximum amplitude distal travel from the centre point, which shall be such that so as to maintain adequate distances from the novel enclosed cage type flapper guiding system 104 also on all sides of the wind turbine if applicable. The rail system 156, part of the bottom base-plate 125, on which roller wheels 157 run, shall have the grooved designs (with diamond/bezel cut at the edges etc) in order to smoothly run through the protruded tooth of the wheels the upper base-plate 158, shall have the same design from inside as is with the bottom base-plate 125.

The Advance harmonic mean predictive control system 135 as defined, shall be part of the wind turbine Main Intelligent Control System 136 for such cases, to generate the nearest & the best predictive harmonic mean of all the pre-failure healthy signals values of each category of failed sensor inputs over a pre-set period of time elapsed (which shall be manually/automatically adjustable) and consequently for generating the near best control signals for the prevailing yaw/pitch controls. The harmonic mean is the only type of mean method considered for all the pre-failure healthy signals and not any other type of mean method such as arithmetic or geometric, because harmonic means work best or has the best predicting structure, in cases where there is unpredictability in process sensor inputs such as wind velocities, wind directions etc (after the respective sensors are at faults or are burned out) to the functional computation systems. Here the major unpredictable inputs are wind velocity, wind direction & wind angle of incidence. Following is the basic tentative control system description along with the algorithms on which the basic core model of this innovative control system 135 will work:

The harmonic mean H of the sensor values with positive real numbers is defined to be

Hwy (wind velocities)=n/(1/X1+1/X2+ . . . +1/Xn)

Hwd (wind directions)=n/(1/Xd1+1/Xd2+ . . . +1/Xdn)

& Hai (angle of incidence)=n/(1/Xa1+1/Xa2+ . . . +1/Xan)

Each of the above mean values of different mentioned wind parameters are then compared with their standard mean available in the embedded databases inside the innovative control system 135, for these various wind parameters average values throughout that period of the day of that week/month/past previous years, with data collected either through experiments or from the metrological/weather department of that particular area considering conditions such as geographical terrains, elevation above mean sea level, temperature, humidity etc. If the difference is marginal i.e within a preset differential value, then the above mentioned harmonic mean will be taken as the final input to the controller, however if the same is above the preset differential value, then higher of the two will be taken as the final input to this controller.

The Main Intelligent Control System 136 (of which control system 135 is a sub-set) shall be such that so as to have sets of intelligent customized sub-algorithms, all interconnected with each other in a star

topology, aiming to produce the most efficient functioning of the wind turbines. For example the neural control for the wind turbine should be like an adaptive controller which has the learning ability to train the neural network so that will allow the turbine to produce the best result possible for a set of given conditions. To accomplish this, the neural network shall have an algorithm so that the final evaluated input error produces the proper control parameter to be applied to the turbine to produce the desired aerodynamic power.

Now let us see how the inventive wind turbine 102 will look like. Following shall be the main features:

It shall have novel solar panel 116 flushed mounted into each of the blade of wind turbine 102, shall have all the features as defined below and the weight selection of the novel solar panel 116 shall be optimised so as to have an increased overall efficiency of the wind turbine 102.

The Enclosed Cage Flapper Guiding systems 104 as defined shall comprise of the followings:

There shall be Cage rods 126, separated in a way so as not to allow hindrances to wind flow. Also there shall be Individual flappers 127 attached to the individual cage rods 126, having free movement facilities.

The separation between the flapper vertical outside edges 128 of the two neighbour flappers shall create relatively small area (i.e as seen from top-view each flapper 127 looks like a

pastry/cake piece with pointed portion at the cage rod 126 & broadest portion towards the wind turbine 102), which shall produce an appreciable pressure drop in order to achieve relatively high wind velocity & uniform wind impingement. The non-uniformity in rotation of the wind-turbine is one of the main drawbacks of this kind of energy production and which also affects the overall functionality & stability of the downstream electrical equipments such as grids, distribution systems. Using this flapper system 127, there shall surely be increased stability & uniformity in the wind energy production depending upon the degree or percentage of use of this type of feature in the entire MESNREI system 100 and is part of the detailed engineering. That means there shall be a trade-off between the separation of the flappers 127 in order to not pose any hindrances to actual wind and the relative small area they shall making for producing high velocity impingement.

Cage type flapper guiding system 104 shall also provide adequate space for any yaw/pitch/pedestal lateral/advanced control movements of wind turbines 102 such that the movements of the specific turbine system 102 components shall not pose any hindrance to the cage type flapper system 104.

The height of the lowest tip 129 of the blades of wind turbines 102/cage type flapper guiding system 104 shall be well above the uppermost edge 130 of the balcony railing system so as to avoid inefficiencies or hindrances in the flow of the wind.

The nearest flapper vertical edge 128 as seen from wind turbine, shall have the surface made in such a way so as to have noise attenuation designs 131, which shall comprise of inscribed/protruded any one of the miscellaneous key-teeth shaped, zig-zag, combed type, stone/brick cladding type, etc to reduce the effect of noise generated from wind turbines.

Noise pollution is one of the main problems of the wind energy production which not only affects the inhabitants residing nearby but also affects the biological ecosystem such as animals, diversion in birds yearly routes, their yearly migration attendance etc. Using these noise attenuation designs 131, there shall surely be a decrease in the level of noise that is generated from among the rotating parts of the wind turbines. The same shall again depend upon the percentage of use of this type of feature in the entire MESNREI system 100 and is part of the detailed engineering.

The most important & inventive part of this system is the new solar photovoltaic shells (miniature or large) 112 (which shall have inner shell part & outer shell part), which shall comprise of the following minimum components:
a) a through hole 113;
b) solar concentrated collector system 114 for concentrating the sunrays through the hole 113;
c) light deflector 132 placed diametrically opposite to the hole 113 inside the shell, such that the inside solar surface 133 behaves as a black body arrangement for utilising maximum incident light energy inside;
d) the position of the said solar concentrated collector system 114 shall be such that, the focal point of the same shall fall at the said light deflector 132;
e) self-supporting structures (including hollow stand/yoke) 134 for holding the large standalone solar photovoltaic shells 112 along with the solar concentrated collector system 114;
f) each inside shell 144 and outside shell 145, shall have n-type/p-type cells arrangements;
g) having a diffuser or an insulator 143 between inside shell 144 and outside shell 145 and the n-p junction 161 between each combination of n-type & p-type cells of each shell. The n-p junction at each of the shell (inside or outside) is the normal n-p junction between any n-type & p-type semiconductors/conductors/any type of photovoltaic cells etc, for current production;
h) electrical interfaces accessories such as solar shells 112 positive metallic grid/electrodes, negative metallic grid/electrodes, ground/earthing leads, connectors, adaptors, cables routed through the hollow vertical stand/yoke/pipe 146 on which larger solar shell 112 is installed as an independent entity or as a standalone. The array of solar shells 112, shall be such that the negative voltage contact of a shell shall be serially connected to the neighbouring shell positive voltage contact in order to produce or behave as a series of batteries etc;
i) a light cum rain sensitive self-adjusting matrix grid assembly 152, beneath these arrangements of solar shells 112, having at least one light & rain sensitive elements 159, electronic circuits, metallic contacts for propagating the produced currents at the pivot/helm 154 (steering the solar shells 112 to the right or left based on sun path or opposite to the rain direction), through the hollow tube/pipe grid assembly for these shells mounted in an array on a panel;
j) inside shell 144 and outside shell 145, shall further have an anti-reflecting transparent coating shell, transparent adhesive shell, tempered toughened glass shell

We all know in terms of efficiency of the conventional solar cells, the same are only of the order of 40-60%, however with the advent of the above features part of the new solar photovoltaic shells (miniature or large) 112, there shall surely be an increase in the efficiency of the same as there is an increase in the surface area due to the spherical curvatures which also utilises the surrounding ambient natural daylight from all the directions and also specially due to the black body arrangements inside shell 144 which most efficiently utilises all of the concentrated sunlight coming inside.

The novel solar panels 116 (including novel solar concentrated collector systems 114), shall comprise of the following:
a) a panel/substrate 149;
b) an array of miniature fully/partially/embedded solar photovoltaic shells 112 as defined above having features from a), b), c), d), f), g), h), i) (optional), j) embedded on the said panel/substrate 149 in matrix form. However miniature solar shells 112 shall be protruded as less as possible from the panel/substrate 149 so as to serve both the purposes of wind & solar energy conversions efficiently. Also, this matrix array of solar shells 112 shall be in such a way so that the scattered lights from the surface shall have some portion also falling on others solar shells 112 placed adjacent to the previous one. The array of solar shells 112, shall be such that the negative voltage contact of a shell shall be serially connected to the neighbouring shell positive voltage contact in order to produce or behave as a series of batteries etc
c) a smooth cavity portion holding each of solar shells 112 i.e either fully or partially or embedded in the panel
d) two-piece retractable modular shutter door 153, with piece-magnet on edges of opposite doors, having motor controlled pivots 160, shutting down/closes when wind turbine 102 goes over a particular pre-defined threshold speed/rain comes or opens up when the speed goes below a certain pre-defined threshold speed/rain goes away. These pre-defined minimum speeds could be manually selected over a selected range of the rated turbine speeds. While opening the doors against the magnetic effects of the piece-magnets, the motor controlled pivots shall be designed to produce required levels of torque to dislodge the piece-magnets.

The portable wind turbines 107 in air floating balloon/parachute enclosures 108 (which could be of any shape, size & designs) for high altitude applications, shall comprise of the following:
a) at least one rigid support consisting of hollow cylindrical piping 109;
b) the said cylindrical piping 109 shall consists of plurality of electrical conducting loops/mesh 110 in all directions, however arranged longitudinally in a particular pattern so as to make the meshes in a single vertical line behaving as if in a series of metallic loops such as small cells are arranged in a series to produce overall high emf c) along with a free moving rod comprising magnets (permanent) 111 at all the same elevations as said electrical loops 110, having both ends tied to the rollers for lateral to/fro movement in the grooves
d) the said moving rod comprising magnets 111, are attached directly to the balloon/parachute enclosures 108 at upper end and to the lower base with an attachment to a roller with groove for to/fro movement facility inside the hollow cylindrical piping 109
e) free movement of rod comprising magnets 111 (due to the movement of balloon/parachute enclosure 109 owing to the effects of natural wind velocity at that height), induces currents in the electrical conducting loops/mesh 110, both near to the north pole side & also away from the south pole, in the same direction according to faraday's laws of electromagnetic induction. The direction of these induced currents are in the same direction as when the magnet north moves towards one metallic loop, the south pole moves away from the another loop. The loops 110 shall be crafted through-out all the directions of the pipe 109, but in the same sequential manner which ensures diagrammatically opposite series of electrical conducting loops/mesh 110. The current rating or current carrying capacity of the loops 110 shall be selected in such a way so as to cater to the preceding cumulative induced currents already coming from upside towards that loop. Also, the cylindrical piping has to be made in such a way to produce the graded voltage potential differences from upside towards downward direction so as to always have the cumulative current direction from top to bottom where the charge collector/amplifying system is there.
f) having an insulator piping array 151 between the cylindrical piping 109 and the free moving rod comprising magnets 111 so as to maintain air gap for above effect to take place without any hindrances
g) a current collector cum transformer/amplifier system 150 for generating large currents Also, in this case, we can have any number of cylindrical piping 109, around one portable wind turbines 107 in air floating balloon/parachute enclosures 108, which shall just multiply the amount of currents produced. Also, the more the elevation, more high the mean annual wind power density at the maximum elevation which inevitably helps to create more wind thrust and thus creates more profound movements, generating higher levels of wind power and induced currents in the cylindrical piping 109.

This current collector cum transformer/amplifier system 150 shall have output connected to the actual converter system dedicated for the actual portable wind turbines 107 in air floating balloon/parachute enclosures 108, so as to jointly produce combined enhanced power

The MESNREI system 100, shall further comprise followings per platform/roof:
a) a plurality of wind turbines 102 on each extended portion 105 of the platform such that, along with a balcony type railing system 115 for safety, access & maintenance
b) the difference of height between two platforms shall be such that the wind turbines 102 installed on the platform shall have adequate minimum over head clearances for safety, interference free, maintenance, any relative aerodynamic effect with wind turbines 102 above or below etc
c) the separation between two wind turbines 102 installed on the same platform shall always have adequate minimum side-side clearances for safety, interference free, maintenance, any aerodynamic effect such as wake effect or any shadow effect etc
d) an array of novel solar panels 116 from all sides and the said novel solar photovoltaic shells 112 (depending on the sun's path) along the railings top edges

The MESNREI system 100, shall also comprise of followings per top roof 106 for on-shore applications:
a) The MESNREI top roof 106 shall also host similar array of wind turbines 102/solar panels as on the platforms 116 & 112;
b) Infrastructures for hoisting interfaces & support connections of numerous portable wind turbines 107 in a high altitude air floating balloon/parachute enclosures 108 along with novel solar panels/shells 116 & 112
c) For very high rise MESNREI system 100, there shall be a helipad 135 at the top roof 106 with stair-case facility from penultimate platform 124 from sides of the roof. In lieu of the helipad 135 arrangement, there shall be an optional novel solar panels/shells
d) arrangements 116 & 112 on the top roof 106 excluding the centre area for elevators/staircase 122;
e) For very low rise MESNREI system 100, there shall be novel solar panels/shells arrangements 116 & 112 on the top roof 106 excluding the centre area for elevators/staircase 122. In lieu of the novel solar panel/shells arrangements 116 & 112,
f) there shall be an optional helipad 135 at the roof top 106 with stair-case 122 facility from penultimate platform 124 from sides of the roof;
g) The starting point of elevators/staircase 122 shall be from the grade level 126 itself for ease of access.

For off-shore applications, the MESNREI system 100, shall comprise of the followings per top roof 106:
a) The MESNREI top roof 106 shall also host similar array of wind turbines 102/solar panels 116 & 112 as on the platforms;
b) Infrastructures for hoisting electrical interface & support connections of numerous portable wind turbines 107 in a high altitude air floating balloon/parachute enclosures 108 along with novel solar panels/shells 116 & 112
c) For very high rise MESNREI system 100, there shall be a helipad 135 at the top roof 106 with stair-case 122 facility from penultimate platform 124 from sides of the roof. In lieu of the helipad 135 arrangement, there shall be optional solar panels/shells arrangement 116 & 112 on the top roof 106 excluding the centre area for elevators/staircase 122;
d) For very low rise MESNREI system 100, there shall be novel solar panels/shells arrangement 116 & 112 on the top roof 106 excluding the centre area for elevators/staircase 122. In lieu of the novel solar panels/shells arrangement 116 & 112, there shall be an optional helipad 135 at the roof top 106 with stair-case 122 facility from penultimate platform 124 from sides of the roof;
e) There shall be an arrangement of stair cum deck system 136 for access to the first platform 121 for people, maintenance team on boats/small ships etc.

This MESNREI system 100, shall have the facilities to host any type of wind turbines 102, whether horizontal axis or vertical axis or any axis wind turbines depending largely upon the application needs or requirements at the end-user, however considering all constraints. The MESNREI system 100, shall have all the provisions for carrying power cables from any type of generators, sensor cables, any other cables from wind turbines 102, portable wind turbines 107 in air floating balloon/parachute enclosures 108, novel solar panels/shells 116 & 112 arrangements, etc being routed through conduits, trays, ducts, etc supported through the various structures & structural components/membranes and then terminated to necessary controllers, circuit breakers, transformers, etc 137, placed at appropriate places therein. From there the power is fed to the collector feeders/battery bank etc 138 and then taken to the inverter cum grid system 139 for feeding to produced power to various DC loads/AC loads respectively.

This shall further have provisions and shall be designed in such a way with sufficient capacity, so as to use the power generated by the wind turbines 102, flying portable wind turbines 107, solar panels/shells 116 & 112 arrangement etc and feed to the electrical & electronic items placed on the MESNREI system 100 or any such thing just near to the same also.

The MESNREI system 100, shall also have necessary provisions, spaces for Data acquisition & monitoring systems 140 comprising of video/image recorders, CCTV cameras etc to collect various video footages and metrological masts or any other similar device etc for the security purpose and metrological data for transferring through various network/communication switches/convertors/wireless networks/cloud servers 141 to the SCADA/system servers 142. Material of construction of various components of this MESNREI system 100 shall be of any material suitable for the specific application.

The main objective of invention is to bring out an inventive Multi-tier Elevated Super-structural Novel Renewable Energy Infrastructures (MESNREI) by which a system could be implemented in order to reduce large land resources, maximise utilisation of wind & solar energy at a particular site through the Multi-tier structural facilities with better achieved efficiency through the novel enclosed cage guided wind turbine systems and the inventive solar shells.

We claim that:

1. Most Wind (Wind-Solar) hybrid infrastructures have large land uses per unit of the less-reliable & lesser efficient wind energy production, pose threat to natural habitat and incur noise pollution along with affecting aesthetics in case of wind farms.
The Multi-tier Elevated Super-structural Novel Renewable Energy Infrastructures (MESNREI) 100 is brought to eliminate all such associated drawbacks, which consists of the followings:
a) A plurality of vertically erected structural platforms 101 placed one above the other for various types of plurality of wind turbines 102 having following inventive/novel features:
i) An harmonic mean predictive Yaw/Pitch control system 135 consisting of intelligent customized sub-algorithms, installed on
ii) Lateral moving pedestal base-plate 103 for to-fro free movement,
iii) Including Enclosed Cage Flapper Guided assembly systems 104, acting as noise attenuation devices/features, for wind turbines 102, as per g on extended portions 105 of the platforms 101 at various elevations.
b) Top roof 106 facility for installing portable wind turbines 107 in air floating balloon/parachute enclosures 108 for high altitudes applications having following features:
i) supports consisting of hollow cylindrical piping 109 consisting of plurality of electrical conducting loops/mesh 110, along with at least 1 free moving rod comprising magnets (permanent) 111 (magnets placed at all of the same elevations as said electrical loops) placed inside each of the hollow cylindrical piping 109,
ii) along with arrangements of solar panels 116 having arrays of protruded larger solar photovoltaic shells (outside & inside) 112 with a hole 113 along with solar concentrated collector systems 114;
c) Balcony type railing systems 115 along the extended portions 105 from all sides at each platform, for hoisting a plurality of solar panels 116 (through the railings top edges 117) containing protruded miniature solar photovoltaic shells 112 with a hole 113 (& inside cavity with light deflector 132 for maximizing light absorption) along with solar concentrated collector systems 114 along the railings top edges 117

2. The MESNREI system 100 as defined in claim 1, shall also comprise of the followings:
a) Industrial/domestic grade type platform grating systems 118 at all platform elevations supported on columns, beams i.e along with all structural components 119, civil/structural foundations 120 such as the pile/pier/raft/cantilever/truss system, that are erected as per industry practices/rules/codes/statutory standards/general standards. The minimum elevation at which first platform 121 shall be build depends on the annual average workable natural wind availability at said particular elevation at that site.
b) At the centre area of the said MESNREI, there shall be an arrangement of elevator/stair-case 122 for going up & down from/to the grade level 123 to the different platform elevations/top roof for on-shore installations. For off-shore installations, there shall be stair-case facility from penultimate platform to the top platform to the top platform, apart from arrangement of elevator/stair-case 122 for going up & down from/to the first platform 121 to the different platform elevations upto the penultimate platform 124.

3. The pedestal base-plate 103 as defined in claim 1, shall comprise of the following:
a) a bottom base-plate 125 (with all mechanical, electrical, electronic components & accessories such as studs, nuts & gaskets 155, having at the least, roller wheels 157 with drum/disc brake, brake shoe lining, return spring, dedicated control system) for feedback lateral to-fro movement control;
b) maximum amplitude distal travel from centre point shall be such so as to maintain adequate distance from the enclosed cage type flapper guiding system 104;
c) the rail system 156, part of the bottom base-plate 125, on which roller wheels run, shall have grooved designs (with diamond/bezel cuts at the edges) in order to smoothly run through the protruded tooth of the wheels 157;
d) the upper base-plate 158 shall have the same design from inside as is with the bottom base-plate 125.

4. The Advance harmonic mean predictive control system 135 as defined in claim 1, shall comprise of the following:
be part of the wind turbine Main Intelligent Control System 136 for cases, to generate the nearest predictive harmonic means of all the pre-failure healthy signals values of each category of failed sensor inputs over a pre-set period of time elapsed (adjustable) for generating the near best control signals for the respective yaw/pitch control. The Main Intelligent Control System 136 shall be such that so as to have sets of intelligent sub-algorithms, all interconnected with each other in a star topology, aiming to produce the most efficient functioning of the wind turbines.

5. The wind turbine 102 as defined in claim 1, shall comprise of the following:
shall have solar panel 116 flushed mounted into each of the blade of wind turbine 102;
shall have all the features as defined in claim 8 below; weight selection of the solar panel shall be optimised so as to have an increased overall efficiency of the wind turbine 102.

6. The Enclosed Cage Flapper Guiding systems 104 as defined in claim 1, shall comprise of the followings:
Cage rods 126, separated in a way so as not to allow hindrances to wind flow;
Individual flappers 127 attached to the individual cage rods 126, having free movement facility;
Separation between the flapper vertical outside edges 128 of the two neighbour flappers shall create relatively small area (i.e as seen from top-view, each flapper 127 looks like a pastry/cake piece with pointed portion at the cage rod 126 & broadest portion towards the wind turbine 102) which shall produce an appreciable pressure drop in order to achieve relatively high velocity & uniform wind impingement;
Cage type flapper guiding system 104 shall provide adequate space for any yaw/pitch/pedestal lateral control movements of wind turbines 102;
Height of the lowest tip 129 of the blades of wind turbines 102/cage type flapper guiding system 104 shall be well above the uppermost edge 130 of the balcony railing system so as to avoid inefficiencies or hindrances in the flow of the wind;
The nearest flapper vertical edge 128 as seen from wind turbine, shall have the surface for noise attenuation designs 131 comprising of inscribed/protruded miscellaneous key-teeth shaped, zig-zag, combed type, stone/brick cladding type, to reduce the effect of noise generated from wind turbines.

7. The solar photovoltaic shells (miniature or large) 112 as defined in claim 1, shall comprise of the following:
a) a through hole 113;
b) solar concentrated collector system 114 for concentrating the sunrays through the hole 113;
c) light deflector 132 placed diametrically opposite to the hole 113 inside the shell, such that the inside solar surface 133 behaves as a black body arrangement for utilising maximum incident light energy inside;
d) the position of the said solar concentrated collector system 114 shall be such that, the focal point of the same shall fall at the said light deflector 132;
e) self-supporting structures (including hollow stand/yoke) 134 for holding the large standalone solar photovoltaic shells 112 along with the solar concentrated collector system 114;
f) each inside shell 144 and outside shell 145, shall have n-type/p-type cells arrangements;
g) having a diffuser or an insulator 143 between inside shell 144 and outside shell 145 and the n-p junction 161 between each combination of n-type & p-type semiconductor/conductor/any photovoltaic cells of each shell;
h) electrical interfaces accessories such as solar shells 112 positive metallic grid/electrodes, negative metallic grid/electrodes, ground/earthing leads, connectors, adaptors, cables routed through the hollow vertical stand/yoke 146 on which larger solar shell 112 is installed as an independent entity;
i) a light cum rain sensitive self-adjusting matrix grid assembly 152, beneath these solar shells 112, having at least one light & rain sensitive elements 159, electronic circuits, metallic contacts for propagating the produced currents at the pivot/helm 154 (steering the solar shells 112 to the right or left based on sun path or opposite to the rain direction in order to avoid entrance of any water inside the cavity), through the hollow tube grid assembly for these shells mounted in an array on a panel.
j) inside shell 144 and outside shell 145, shall further have an anti-reflecting transparent coating shell, transparent adhesive shell, tempered toughened glass shell;

8. The solar panels 116 as defined in claim 1, shall comprise of the following:
a) a panel/substrate 149;
b) an array of fully/partially/embedded miniature solar photovoltaic shells 112 as defined in claim 7 above having features from 7 a), b), c), d), f), g), h), i) (optional), j) on the said panel/substrate 149 in matrix form;
c) a smooth cavity portion holding each of solar shells 112;
d) two-piece retractable modular shutter door 153, with piece-magnet on edges of opposite doors, having motor controlled pivots 160 shutting down/closes when wind turbine 102 goes over a particular pre-defined threshold speed/rain comes or opens up when the speed goes below a certain pre-defined threshold speed/rains goes away.

9. The portable wind turbines 107 in air floating balloon/parachute enclosures 108 for high altitudes applications as defined in claim 1, shall comprise of the following:
a) at least one rigid support consisting of hollow cylindrical piping 109;
b) the said cylindrical piping 109 shall consists of plurality of electrical conducting loops/mesh 110 in all directions;
c) along with a free moving rod comprising magnets (permanent) 111 at all the same elevations as said electrical loops 110, having both ends tied to rollers for lateral to/fro movement in the grooves;
d) the said moving rod comprising magnets 111, are attached directly to the balloon/parachute enclosures 108 at upper end and to the lower base with an attachment to a roller with grooves, for to/fro movement facility inside the hollow cylindrical piping 109;
e) free movement of rod comprising magnets 111 (due to the movement of balloon/parachute enclosure 109), induces current in the electrical conducting loops/mesh 110, both near to the north pole side & also away from the south pole, in the same direction according to faraday's laws of electromagnetic induction;
f) having an insulator piping array 151 between the cylindrical piping 109 and the free moving rod comprising magnets 111 so as to maintain air gap for above effect;
g) a current collector cum transformer/amplifier system 150 for generating large currents.

10. The MESNREI system 100 as defined in claim 1, shall comprise followings per platform/roof:
a) a plurality of wind turbines 102 on each extended portion 105 of the platform, along with balcony type railing system 115 for safety, access & maintenance;
b) the difference of height between two platforms shall be such that the wind turbines 102 installed on the platform shall have adequate minimum over head clearances for safety, interference free, maintenance, any relative aerodynamic effect with wind turbines 102 above or below;
c) the separation between two wind turbines 102 installed on the same platform shall always have adequate minimum side-side clearances for safety, interference free, maintenance, any aerodynamic effect such as wake effect or any shadow effect;
d) an array of solar panels 116 from all sides and the said solar photovoltaic shells 112 (depending on the sun's path) along the railings top edges;

11. The MESNREI system 100 as defined in claim 1, shall comprise of followings per top roof 106 for on-shore applications:
a) The MESNREI top roof 106 shall also host similar array of wind turbines 102/solar panels 116 & 112 as on the platforms;
b) Infrastructures for hoisting interfaces & support connections of numerous portable wind turbines 107 in high altitude air floating balloon/parachute enclosures 108 along with solar panels/shells 116 & 112;
c) For very high rise MESNREI system 100, there shall be a helipad 135 at the top roof 106 with stair-case facility from penultimate platform 124 from sides of the roof. In lieu of the helipad 135 arrangement, there shall be an optional solar panels/shells arrangements 116 & 112 on the top roof 106 excluding the centre area for elevators/staircase 122;
d) For very low rise MESNREI system 100, there shall be solar panels/shells arrangements 116 & 112 on the top roof 106 excluding the centre area for elevators/staircase 122. In lieu of the solar panel/shells arrangements 116 & 112, there shall be an optional helipad 135 at the roof top 106 with stair-case 122 facility from penultimate platform 124 from sides of the roof;
e) The starting point of elevators/staircase 122 shall be from the grade level 126, for ease of access.

12. The MESNREI system 100 as defined in claim 1, shall comprise of the followings per top roof 106 for off-shore applications:
a) The MESNREI top roof 106 shall also host similar array of wind turbines 102/solar panels 116 & 112 as on the platforms;
b) Infrastructures for hoisting electrical interface & support connections of numerous portable wind turbines 107 in a high altitude air floating balloon/parachute enclosures 108 along with solar panels/shells 116 & 112;
c) For very high rise MESNREI system 100, there shall be a helipad 135 at the top roof 106 with stair-case 122 facility from penultimate platform 124 from sides of the roof. In lieu of the helipad 135 arrangement, there shall be optional solar panels/shells arrangement 116 & 112 on the top roof 106 excluding the centre area for elevators/staircase 122;
d) For very low rise MESNREI system 100, there shall be solar panels/shells arrangement 116 & 112 on the top roof 106 excluding the centre area for elevators/staircase 122. In lieu of the solar panels/shells arrangement 116 & 112, there shall be an optional helipad 135 at the roof top 106 with stair-case 122 facility from penultimate platform 124 from sides of the roof;
e) There shall be an arrangement of stair cum deck system 136 for access to the first platform 121 for people, maintenance team on boats/small ships.

13. The MESNREI system 100 as defined in claim 1, shall have the facilities to host any type of wind turbines 102 with any type of generators, whether horizontal axis or vertical axis or any axis wind turbines depending largely upon the application needs considering all constraints.

14. The MESNREI system 100 as defined in claim 1, shall have all provisions for carrying power cables from any type of generators, sensor cables, any other cables from wind turbines 102, portable wind turbines 107 in air floating balloon/parachute enclosures 108, novel solar panels/shells 116 & 112 arrangements, being routed through conduits, trays, ducts, supported through the structures & structural components and then terminated to necessary controllers, circuit breakers, transformers 137, placed at appropriate places therein, from where the power is fed to the collector feeders/battery bank 138 and then to inverter cum grid system 139 for feeding to various DC loads/AC loads respectively.

15. The MESNREI system 100 as defined in claim 1, shall have provisions to use the power generated by the wind turbines 102, flying portable wind turbines 107, solar panels/shells 116 & 112 arrangement and feed to the electrical & electronic items placed on the MESNREI system 100.

16. The MESNREI system 100 as defined in claim 1, shall also have necessary provisions, spaces for Data acquisition & monitoring systems 140 comprising of video/image recorders, CCTV cameras, to collect various video footages, metrological masts for metrological data and any other similar device etc for security purpose, transferring data through various network/communication switches/convertors/wireless networks/cloud servers 141 to the remote SCADA/system servers 142.
